(19) United States
(12) Patent Application Publication
(10) Pub. No.: US 2009/0033466 A1
(43) Pub. Date: Feb. 5, 2009

(54) Tag Identification System, Tag Reading Apparatus, and Method for Determining Location of Tags

(75) Inventors: CHEN SONG, Beijing (CN); Bo Zhou, Beijing (CN); Yabo Wang, Beijing (CN); Xiaowei Liu, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC(CHINA) Co., Ltd., Beijing (CN)

(21) Appl. No.: 12/182,381

(22) Filed: Jul. 30, 2008

(30) Foreign Application Priority Data
Jul. 30, 2007 (CN) 2007/10135862.5

(51) Int. Cl. H04Q 5/22

(52) U.S. Cl. 340/10.1

(57) ABSTRACT

The invention provides a tag identification system, a tag reading apparatus, and a method for determining location of tags. According to an aspect of the invention, a tag identification system comprises a tag reading apparatus which transmits interrogation signals and a plurality of tags arranged in a sequence, wherein each of the plurality of tags is capable of returning a reply in response to a received interrogation signal; the tag reading apparatus at least comprises a location determination unit which determines the arrangement location of the plurality of tags based on replies received by the tag reading apparatus which are returned by the plurality of tags in response to interrogation signals.

### TECHNICAL FIELD

The invention generally relates to computer systems, and more particularly, to a tag identification system, a tag reading apparatus, and a method for determining location of tags.

### BACKGROUND

As a technique for performing noncontact bi-directional communication via radio frequency to exchange data for the purpose of identification, Radio Frequency Identification (RFID) is gaining increasingly wide application.

A typical RFID system generally includes two parts, namely an RFID reader and an RFID tag. The RFID tag is located on the object to be identified and is the data carrier in the RFID system. A typical RFID tag includes a microchip that stores data and a coupling element, such as a coiled antenna, for carrying out radio frequency communication with the RFID reader. RFID tags may be either active or passive. Active RFID tags have an on-tag power supply (such as a battery) and can actively send an RF signal for communication, while passive RFID tags obtain all of their power from the interrogation signal of the RFID reader and either reflect or load modulate the RFID reader's signal for communication. Most RFID tags, both passive and active, communicate only when they are interrogated by an RFID reader.

An RFID reader can read data from an RFID tag and/or write data to the RFID tag. A typical RFID reader includes a radio frequency module, a controller, and a coupling element (such as an antenna) to carry out radio frequency communication with an RFID tag. In addition, many RFID readers are fitted with an information reading interface that enables them to communicate their received data to a data processing subsystem, e.g., a database running on a personal computer.

In most RFID systems, an interrogation signal transmitted by an antenna of an RFID reader can be received by a tag within the coverage (also referred to as “RF region” hereinafter) of the antenna. The size of the coverage depends on the operating frequency of the RFID reader and the size of the antenna. When an RFID tag is within the coverage of the antenna, it can detect the interrogation signal of the reader, and transmit as reply the information or data on the object to be identified stored therein in response to the interrogation signal. The reader identifies the object identified by the RFID tag according to the received reply returned from the RFID tag.

Compared with contemporary or prior identification techniques such as barcode, magnetic card, IC card or the like, RFID bears such advantages as noncontactness, wide operating range, adaptation to hostile environment, and the like. Due to these advantages, RFID has been increasingly used in management of high density warehouse, library and the like. However, individual management is harder than batch management in RFID application layer, as shown in FIG. 1.

One important case in high-density management is the individual location problem in warehouse or library management. Existing methods meet challenge because collision happens which throws the order into confusion and batch information is useless for individual location management.

Currently, it is difficult to detect individual order (relation location) of RFID tags in a high-density sequence because:

1. When an RFID reader transmits a signal to tags, more than one tag can answer the reader simultaneously.

2. The RFID reader can read a number of tags simultaneously. However, the information read is simple and confused in order, as shown in FIG. 2.

3. Collision happens when multiple tags enter RF region simultaneously. Collision throws the natural order into confusion completely, which is mainly manifested as
a. State information is unreliable due to lack of internal power source in the tag in the case of passive tags.
b. Tags cannot communicate with each other. This is a special case of the multiple channel access communication issue.
c. Tags have limited memory and computation capabilities. There exists little calculation possible at tags.
d. Existing researches focus on anti-collision technology, which is basically helpless for detecting the correct order of a high-density sequence.

4. Individual location detection efficiency will be a bottleneck as the anti-collision capacity of the reader increases. Current readers can read more than 600 C1 G2 (Class 1 Generation 2) tags per second. However, it will take about tens of milliseconds to read a single tag in real environment for a special RFID reader. That is, the “global scroll” efficiency is less than “inventory” efficiency.

Thus, it is a problem to be solved to determine the correct order or individual location of high-density RFID tags. The model of the problem is shown in FIG. 3.

Confused order information means the observed order information is not equal to the true order information of a high-density sequence. That is, the observed value of \vec{S}={B→A} is \vec{S}=({A→B} or {B→A}). The confused sequence information has the following characteristics:

a. Collision occurs when objects A and B exist in the observed region simultaneously

b. There exists a short period in which only individual A presents before collision begins

c. There exists a short period in which only individual B presents after collision finishes

d. No precise method to distinguish the bound of single object and multiple objects and control the observation.

e. The interval between objects A and B is uncertain.

Numerous tags can be present in the interrogation area of an RFID reader. A reader in an RFID system can transmit an interrogation message to the tags. Upon receiving the message, all tags send a response back to the reader. If more than one tag responds, their responses will collide in the RF communication channel, and thus cannot be received by reader. The problem of solving this collision is generally referred to as the anti-collision problem, and the ability to solve this is an important ability.

The simplest of all the multi-access procedures is the ALOHA procedure. As soon as a data packet is available it is sent from the tag to the reader. This is a tag-driven stochastic TDMA procedure. The procedure is used exclusively with read-only tags, which generally have to transfer only a small amount of data (serial numbers), this data being sent to the reader in a cyclical sequence. The data transmission time represents only a fraction of the repetition time, so there are relatively long pauses between transmissions. Furthermore, the repetition times for the individual tags differ slightly. There is therefore a certain probability that two tags can transmit their data packets at different times and the data packets will not collide with one another. The time sequence of a data transmission in an ALOHA system is shown in FIG. 4.

Some kinds of slotted Aloha protocol are broadly used as the basic concept of anti-collision method in commercial tag products, for example, ‘I-code’ by PHILIPS, ISO/IEC-18000-6C and so on. The main idea of this algorithm is to speed up the inventorying process by decreasing useless slots, vacant or collided. However, it is helpless to decide the sequence that RFID tags enter RF region because the correct order has been thrown into confusion by the random selection method in Aloha and related anti-collision algorithm.

The existing researches focus on how to read a possible great number of tags in shortest time. It is helpless or even misleading in detecting the correct order of a high-density sequence. The purpose of existing researches is shown in FIG. 5.

As described above, existing solutions focus on large-power method for reading large-number tags. Current anti-collision algorithms throw the order of multiple tags into confusion completely. These methods provide approaches to detect multiple tags in a short time. However, the information read merely includes those that bear no relationship with sequence, such as number, crude time, etc.

It can be seen that there is a need for a system and method for practically and efficiently detecting the relative location of high-density RFID tags.

### SUMMARY OF THE INVENTION

The object of the invention is to provide a tag identification system, a tag reading apparatus, and a method for determining location of tags, which practically and efficiently detects the relative arrangement location of high-density RFID tags.

According to a first aspect of the invention, there is provided a tag identification system, comprising a tag reading apparatus which transmits interrogation signals and a plurality of tags arranged in a sequence, wherein each of the plurality of tags is capable of returning a reply in response to a received interrogation signal; the tag reading apparatus at least comprises a location determination unit which determines the arrangement location of the plurality of tags based on replies received by the tag reading apparatus which are returned by the plurality of tags in response to interrogation signals.

According to a second aspect of the invention, there is provided a tag reading apparatus capable of transmitting an interrogation signal and receiving a reply returned from a tag, comprising: a location determination unit which determines the arrangement location of a plurality of tags arranged in a sequence based on replies received by the tag reading apparatus which are returned by the plurality of tags in response to a plurality of interrogation signals transmitted from the tag reading apparatus.

According to a third aspect of the invention, there is provided a method for determining the arrangement location of a plurality of tags using a tag reading apparatus, comprising: an interrogation signal transmitting step for transmitting a plurality of interrogation signals to the plurality of tags from the tag reading apparatus; and a location determination step for determining the arrangement location of the plurality of tags based on replies received by the tag reading apparatus which are returned by the plurality of tags in response to the plurality of interrogation signals.

The technical solution of the invention substantially attains the following technical effects:

1. Information is precisely classified as to whether it comes from a single-region or a multiple-region, and it is easier to catch a single-region;

2. Approaches and criteria for determining the size of a RF region suitable for sequence detection are provided;

3. It is Easy to deploy
a. for readers with different frequencies,
b. for different distance requirements, and
c. for different communication speeds;

3. It is independent of anti-collision algorithm or protocol; and

4. It has a reliable detection correct ratio.

The above and other features and advantages of the invention will be described in detail below with reference to the drawings.

### DESCRIPTION OF THE DRAWINGS

FIG. 1 shows the difficulty of individual management in RFID application layer;

FIG. 2 shows the problem of confused order due to simultaneous responses by multiple tags;

FIG. 3 shows the model of the problem of determining the correct order of high-density tags;

FIG. 4 shows the time sequence of a data transmission in an ALOHA system;

FIG. 5 shows the purpose of existing researches;

FIG. 6 shows a schematic diagram of an RFID system according to an embodiment of the invention;

FIG. 7 is a schematic block diagram showing the structure of the RFID reading apparatus shown in FIG. 6;

FIG. 8 shows the optimal attenuation level and reliable RF region.

FIG. 9 schematically shows the regions that may exist when multiple tags are read;

FIG. 10 shows the effects of different picking methods;

FIG. 11 shows the basic principle of Ordinal Optimization;

FIG. 12 shows the basic principle of the picking method according to the invention;

FIG. 13 shows the theoretical comparison between Pure BP algorithm and the method of the invention; and

FIG. 14 shows the operation flow of the RFID reading apparatus in the RFID system shown in FIG. 6 for determining the arrangement location of a plurality of RFID tags;

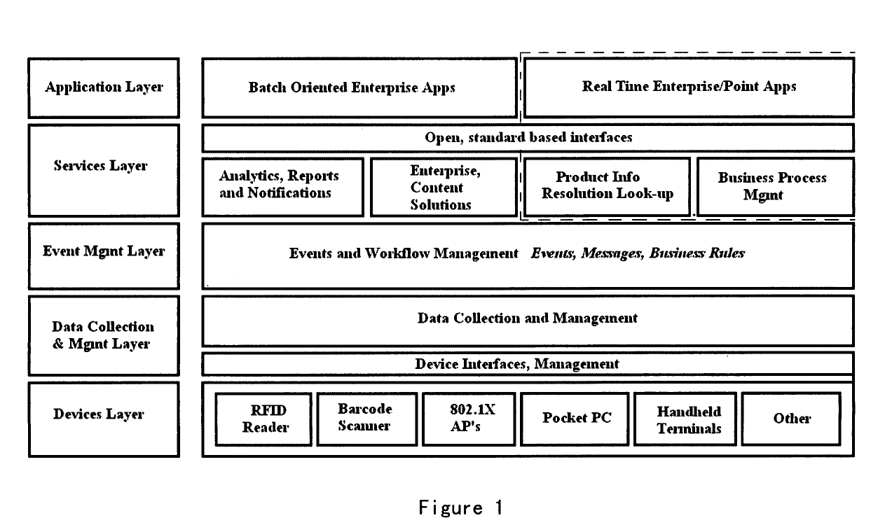

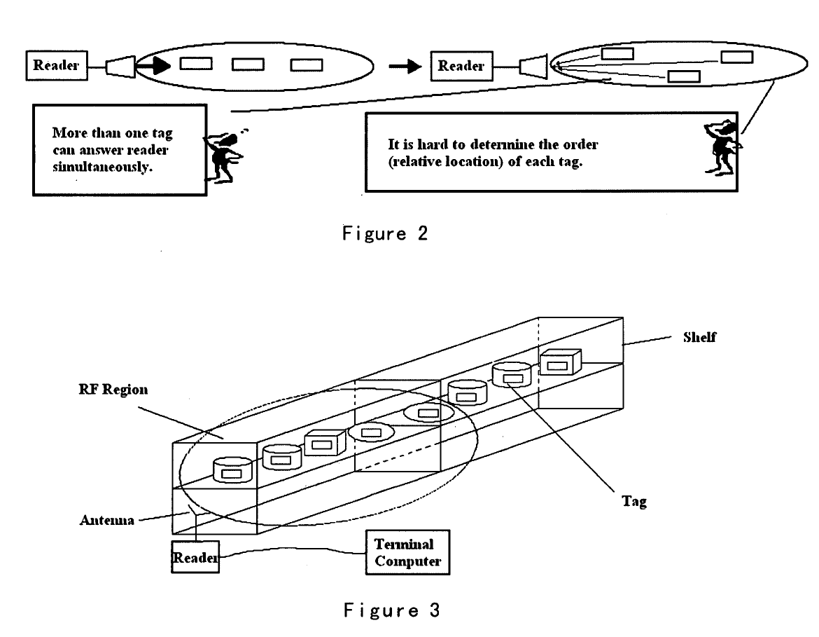

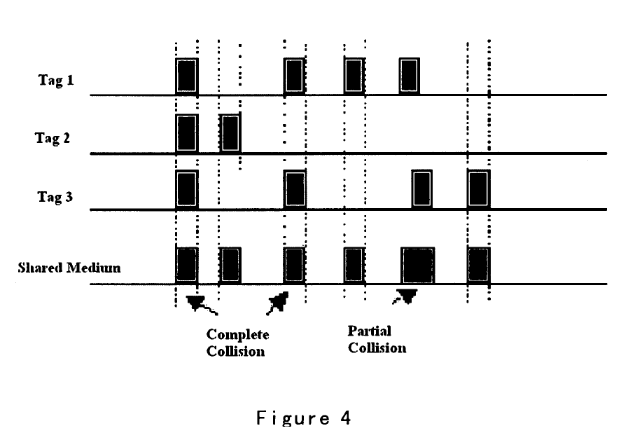

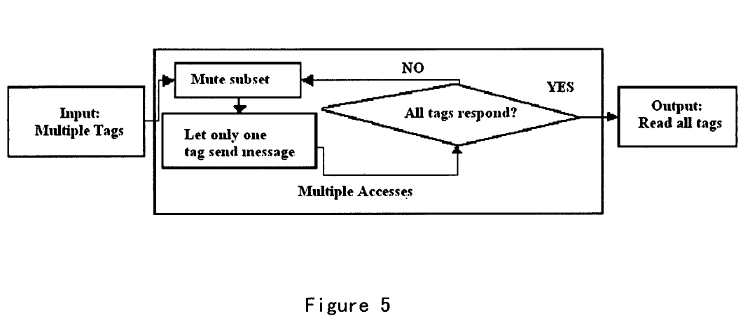

### DETAILED DESCRIPTION

Hereinafter, the features and advantages of the invention will be described in detail in connection with preferred embodiments of the invention with reference to the drawings.

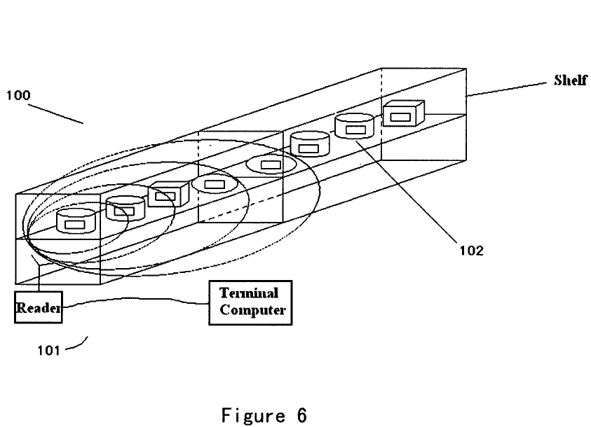

FIG. 6 shows a schematic diagram of an RFID system 100 according to an embodiment of the invention. The embodiment represents the case of managing items on a shelf. It is to be appreciated by those skilled in the art that the RFID system according to the invention is also applicable to management systems in warehouse, library and the like, to determine the spatial locations of the objects to be identified, and to draw a spatial schematic view through identifications in various locations.

As shown in FIG. 6, the RFID system 100 of the embodiment of the invention includes an RFID reading apparatus 101 and a plurality of RFID tags 102. Items attached with RFID tags 102 are placed on a shelf, and the intervals therebetween are uncertain and random, such that the tags form a high-density sequence. RFID reading apparatus 101 transmits interrogation signals to those tags on the shelf, and determines the relative location of the tags on the shelf according to the replies returned from the tags in response to the interrogation signals, so as to further manage the items attached with the tags. In the system of FIG. 6, there is further shown a terminal computer connected with the RFID reading apparatus 101 for processing the data received by the RFID reading apparatus 101. As will be appreciated by those skilled in the art, the invention is not limited thereto. The ability of processing data can also be integrated into the RFID reading apparatus 101.

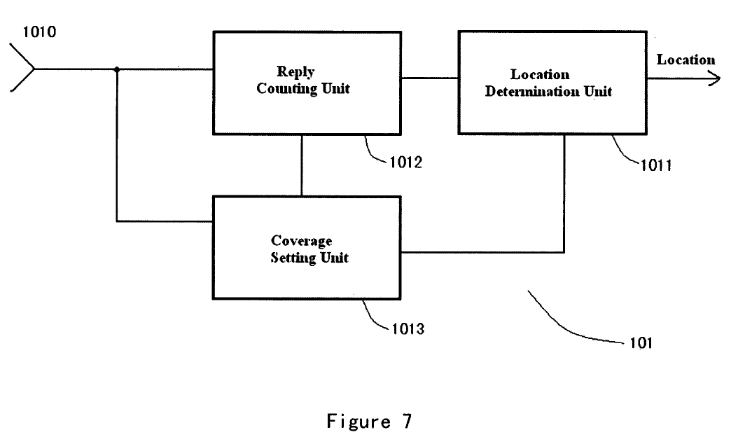

FIG. 7 is a schematic block diagram showing the structure of the RFID reading apparatus 101. As shown in FIG. 7, the RFID reading apparatus 101 according to the invention includes an antenna 1010 for transmitting and receiving data through radio frequency communications. The antenna has a corresponding coverage, and tags within the coverage can receive an interrogation signal transmitted by the RFID reading apparatus 101 through the antenna and can return a reply in response to the interrogation signal such that the RFID reading apparatus 101 can receive the reply through the antenna.

The RFID reading apparatus 101 includes a location determination unit 1011, and optionally a reply counting unit 1012 and a coverage setting unit 1013.

The location determination unit 1011 determines the arrangement location of tags 102 based on replies received by the antenna 1010 which are returned from the tags 102.

The reply counting unit 1012 counts the number of tags among the plurality of tags which have returned replies in response to one interrogation signal, and sends the result of the counting to the location determination unit. Specifically, the reply counting unit 1012 implements an information classification function, that is, to classify the received information by determining how many tags the received replies are returned from. More specifically, the reply counting unit 1012 classifies the replies in response to one interrogation signal received by the antenna to determine whether the replies come from a single-region or a multiple-region, and to determine, if the replies come from a multiple-region, whether they come from a nearest-multiple-region (NM-region), and sends the result to the location determination unit 1011. Here, a single-region means the received replies include only a reply returned from one tag, a multiple-region means the received replies include replies returned from more than one tag, and a nearest-multiple-region means the number of replies in response to the current interrogation signal is 1 greater than the number of replies in response to the previous interrogation signal, that is, the number of tags which have received the current interrogation signal and made a reply is 1 greater than the number of tags which have received the previous interrogation signal and made a reply.

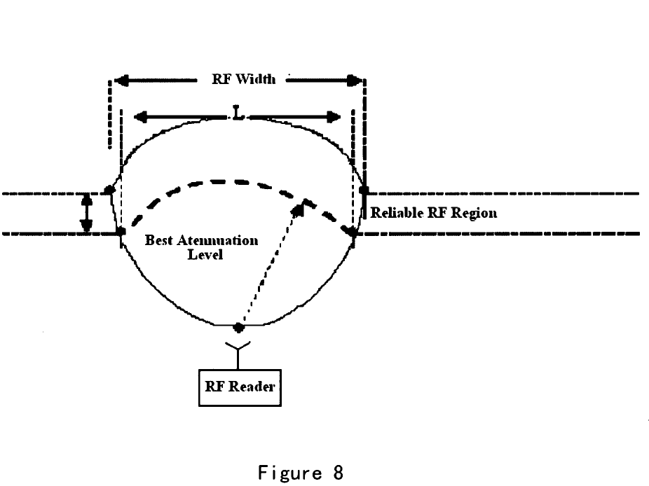

The coverage setting unit 1013 is used to set the coverage of the RFID reading apparatus 101, that is, the coverage of the antenna 1010, so that only a particular number of tags among the tags 102 can receive an interrogation signal transmitted by the RFID reading apparatus 101 through the antenna 1010. The optimal attenuation level and reliable RF region are shown in FIG. 8.

Specifically, the coverage setting unit 1013 sets, based on replies received by the RFID reading apparatus 101 which are returned in response to a previous interrogation signal, the coverage of the antenna 1010 when a current interrogation signal is transmitted, so that the number of tags which can receive the current interrogation signal among the plurality of tags 102 is 1 greater than the number of tags which can receive the previous interrogation signal among the tags 102.

Furthermore, when the RFID reading apparatus 101 transmits an interrogation signal to the plurality of tags 102 for the first time, the coverage setting unit 1013 sets the coverage of the antenna so that only one of the plurality of tags 102 can receive this first interrogation signal transmitted by the RFID reading apparatus 101.

Actually, the operations of the location determination unit 1011, reply counting unit 1012 and coverage setting unit 1013 in the RFID reading apparatus 101 of the invention, as a whole, form an approach to identify the arrangement location of tags based on Information Partition and Ordinal Optimization (OO). The principles and features thereof will be described in detail below.

As described above, the reply counting unit 1012 classifies the replies received by the antenna to determine whether the replies come from a single-region or a multiple-region, and to determine, if the replies come from a multiple-region, whether they come from a nearest-multiple-region (NM-region).

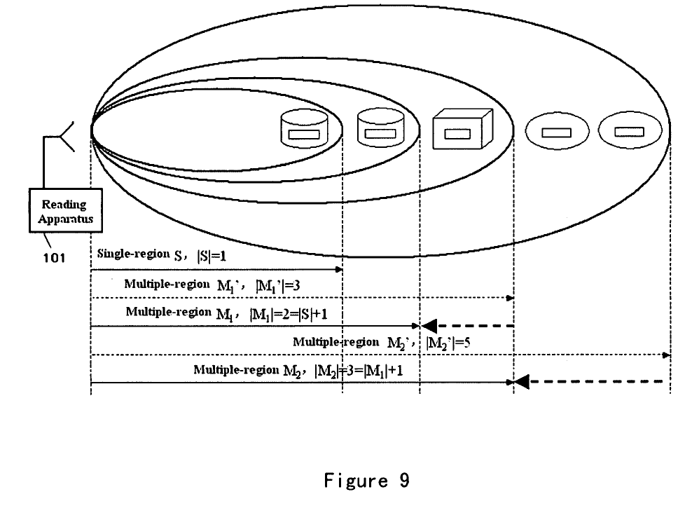

This Information Partition method in the reply counting unit 1012 will be explained in detail below. The Information Partition method carried out in the reply counting unit 1012 divides the read region into single-region and multiple-region. There exist 2 kinds of regions in reading multiple objects, as shown in FIG. 9. Suppose there are three objects A, B and C on the shelf in the order (relative location) of “A first, B second, C third”: {C→B→A}. The three objects A, B and C are attached with tag 102A, tag 102B and tag 102C respectively.

1. If the RF region can only cover the nearest RFID tag, i.e. the tag 102A of object {A} is read, the region is called “single-region”.

2. If the RF region can cover multiple RFID tags, i.e. the tags of objects {A, B} or {A, B, C} are read, the region is called “multiple-region”.

Successful sampling in Mᵢ region is a key factor for deciding the correct order of adjacent objects. The size of region should satisfy following condition

$$\{ \begin{matrix}\vert {M}_{i} \vert = \vert S \vert + 1 & i = 1 \\ \vert {M}_{i} \vert = \vert {M}_{i - 1} \vert + 1 & i > 1\end{matrix}$$

That is to say, from single-region to multiple-region, if one can catch the “nearest-multiple-region” (NM-region), the order of the tags can be decided. The nearest-multiple-region is a region whose size is 1 larger than that of the previous region.

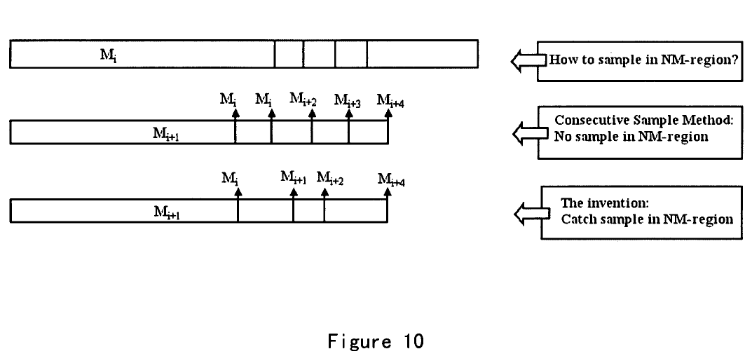

How to pick sample in order to catch NM-region is a crucial problem. Conventional consecutive sample methods are not efficient, as shown in FIG. 10. It is very likely that other multiple-regions instead of NM-regions are captured. However, without NM-region, it is impossible to decide the correct order. Therefore, the key idea of the approach of the invention is to propose an approach to catch NM-region.

As mentioned above, it is hard for precise method to catch NM-region because it is hard to distinguish the boundary between NM-regions. Therefore, a crude method on the basis of Ordinal Optimization (OO) is proposed in this invention. The effect of different pick methods is shown in FIG. 10.

The purpose of the problem is to obtain good enough designs through searching and selecting designs in a design space. Exhaustive search is generally inefficient and even impossible, which results in a very large selected subset. The search space is very huge and unlimited because it is a continuous space. Therefore, the problem must be formulated in an optimization problem of discrete event systems (DES).

Ordinal Optimization (OO) is a simulation based optimization method proposed by Prof Ho in 1990's. The Ordinal Optimization method offers an efficient way to simulation based optimization approach. It intends to find a good or satisfying solution among a large number of candidates rather than the true optimum with a computationally simple but possibly crude model to estimate the performance of a set of plans or choices. The good enough choices are defined as a set that can be quantified and determined with high probability. Based on the crude model, a subset of these choices, called selected subset S, is selected as the observed “good enough” set. Ordinal Optimization may then quantify the degree of “matching” or “alignment” between the set S and the true good enough subset G. Ordinal Optimization is particularly attractive for stochastic discrete optimization since it is immune to large noise with affordable computational complexity.

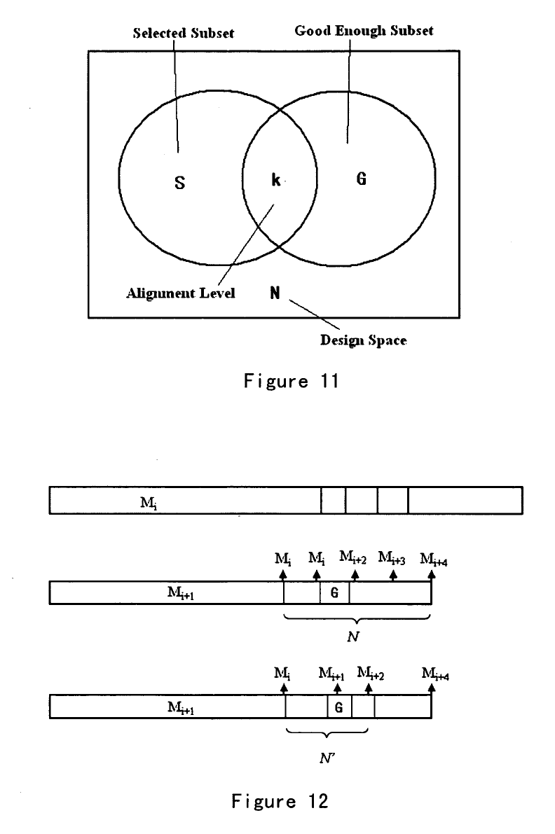

As explained above, the basic idea of Ordinal Optimization is based on two tenets: ordinal comparison and goal softening. First, it is much easier to determine whether or not decision A is better than B than determining “A−B=?”. The relative order of A vs. B converges exponentially fast while the “value” converges at a rate of 1/t^{1/2}. Accurate cardinal value may not be necessary when determining which one of A and B is better. It emphasizes the choice (order) rather than estimating the utility (value) of the choices. Another key idea of Ordinal Optimization is goal softening by maintaining reasonable “matching” outcomes between the good enough subset G and the selected subset S with efficiency and confidence. The criterion for the good enough subset G is chosen as the top n-percentile of the decision space without the need to find the true optimum. The basic idea of Ordinal Optimization is shown in FIG. 11.

The meaning of “alignment probability (AP)” will be explained first. For unconstrained problems, by “matching” or “alignment”, we mean the intersection of the good enough subset G and the selected subset S. AP is defined as:

AP=Prob{|G∩S|≧k} (1)

where k is called the alignment level.

Blind Picking (BP) as a selection rule involves selecting a subset S from decision space Θ:1) randomly, 2) without replacement, and 3) without comparison. This selection rule would warrant that every decision has the same tendency to be evaluated to any rank in the decision space. In addition the AP for this special case can be expressed in a closed form, i.e.,

$$AP ( \vert G ⋂ S \vert \geq k ) = {\sum }_{i = k}^{min ( g , s )} \frac{( \begin{matrix}g \\ i\end{matrix} ) ( \begin{matrix}N - g \\ s - i\end{matrix} )}{( \begin{matrix}N \\ s\end{matrix} )} \qquad ( 2 )$$

which is the hypergeometric distribution, where N is the size of decision space. For the blind picking case, the AP depends on:
1. The alignment level k;
2. The size of the good enough subset G (i.e., |G|=g); and
3. The size of the selected subset S (|S|=s).

The general Ordinal Optimization problem can be formulated into the following optimization problem:

Min |S| (3)

s.t. |{Θᵢ|Θᵢ={A} or Θᵢ={B}|>0; (4)

|Θ|=N; (5)

|G|=r %·N (top−r % of Θ) (6)

Prob(|G∩S|>k)>P_{req} (7)

where
S={Θ₁,Θ₂, . . . , Θₛ}- - - Selected subset, |S|=s
Θᵢ - - - the set of tag label at time tᵢ
Θ - - - Design space
G - - - Good enough subset, |G|=g
k - - - Alignment Level

The probability of that the alignment level between G and S is k is:

$$Prob ( \vert G ⋂ S \vert = k ) \frac{( \begin{matrix}g \\ k\end{matrix} ) ( \begin{matrix}N - g \\ s - k\end{matrix} )}{( \begin{matrix}N \\ s\end{matrix} )} \qquad ( 8 )$$

Therefore, the probability of that the alignment level between G and S at least is k is:

$$Prob ( \vert G ⋂ S \vert \geq k ) = {\sum }_{i = 1}^{min ( g , s )} \frac{( \begin{matrix}g \\ i\end{matrix} ) ( \begin{matrix}N - g \\ s - i\end{matrix} )}{( \begin{matrix}N \\ s\end{matrix} )} \qquad ( 9 )$$

Therefore the minimal size of the selected subset S is

$$s = arg ( {\sum }_{i = 1}^{min ( g , s )} \frac{( \begin{matrix}g \\ i\end{matrix} ) ( \begin{matrix}N - g \\ s - i\end{matrix} )}{( \begin{matrix}N \\ s\end{matrix} )} \geq {P}_{r} ) \qquad ( 10 )$$

For the case in high-density RFID sequence detection of the invention, S is the times that RF region is adjusted, in another word, it is also the selected subset in sample space. G is the NM-region. N is sample space with all possible regions. In order to catch sample in NM-region, the key problems are how many times the RF region needs to be adjusted.

If the simple Blind Picking method is applied in this case, the design space is N and good enough subset is G, as shown in FIG. 12. Only picking sample in G region can catch sample in NM-region. Only if the sample in NM-region is detected, the sequence can be determined. The probability of {S reads include at least k single-regions} is:

$$Prob ( \vert G ⋂ S \vert \geq k ) = {\sum }_{i = 1}^{min ( g , s )} \frac{( \begin{matrix}g \\ i\end{matrix} ) ( \begin{matrix}N - g \\ s - i\end{matrix} )}{( \begin{matrix}N \\ s\end{matrix} )} \qquad ( 11 )$$

### Therefore,

$$s = arg min ( {\sum }_{i = 1}^{min ( g , s )} \frac{( \begin{matrix}g \\ i\end{matrix} ) ( \begin{matrix}N - g \\ s - i\end{matrix} )}{( \begin{matrix}N \\ s\end{matrix} )} \geq {P}_{r} ) \qquad ( 12 )$$

The problem is how to improve the blind picking method. After all, it is not efficient because it needs a large number of detectors to catch samples in single-region. According to No-Free-lunch Theorem: no algorithm can do better on the average than blind search without structural information. Therefore, it is needed to find structural information to improve the efficiency. It has been found that the main reason that sample in NM-region cannot be caught is the design space is too “large”. Therefore, if one can reduce the size of design space, the probability of catching NM-region can be improved. Usually the adjustment method depends on the practical environment to improve the picking effect. The basic principle is shown in FIG. 12.

Suppose the increased size is AN, the size of design space becomes N-ΔN. Therefore, The probability of {S reads include at least k single-regions} is:

$$Prob ( \vert G ⋂ S \vert \geq k ) = {\sum }_{i = 1}^{min ( g , s )} \frac{( \begin{matrix}g \\ i\end{matrix} ) ( \begin{matrix}N - Δ N - g \\ s - i\end{matrix} )}{( \begin{matrix}N - Δ N \\ s\end{matrix} )} \qquad ( 13 )$$

### Therefore

$$s = arg min ( {\sum }_{i = 1}^{min ( g , s )} \frac{( \begin{matrix}g \\ i\end{matrix} ) ( \begin{matrix}N - Δ N - g \\ s - i\end{matrix} )}{( \begin{matrix}N - Δ N \\ s\end{matrix} )} \geq {P}_{r} ) \qquad ( 14 )$$

Thus the improvement in the probability is

$$Δ Prob ( \vert G ⋂ S \vert \geq k ) = {\sum }_{i = 1}^{min ( g , s )} ( \begin{matrix}g \\ i\end{matrix} ) ( \begin{matrix}\frac{( \begin{matrix}N - Δ N - g \\ s - i\end{matrix} )}{( \begin{matrix}N - Δ N \\ s\end{matrix} )} - \\ \frac{( \begin{matrix}N - g \\ s - i\end{matrix} )}{( \begin{matrix}N \\ s\end{matrix} )}\end{matrix} ) \qquad ( 15 )$$

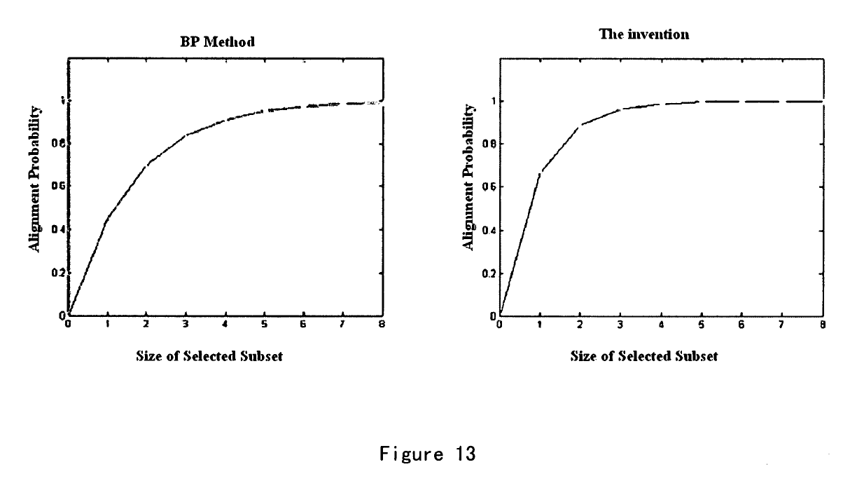

Suppose the size of design space is 200, and the size of good enough set is 80 ms. If the size of design space can be reduced to 120, the probability of successfully picking NM-region will be improved greatly on the basis of Eq. 14. The theoretical comparison between Pure BP algorithm and the method of the invention is shown in Table 1 and FIG. 13:

TABLE 1

| | Reads# | | | | | | | |
|---|---|---|---|---|---|---|---|---|
| | 1 | 2 | 3 | 4 | 5 | 6 | 7 | 8 |
| BP | 0.4000 | 0.6412 | 0.7862 | 0.8730 | 0.9248 | 0.9557 | 0.9740 | 0.9847 |
| IDEA | 0.6667 | 0.8908 | 0.9648 | 0.9889 | 0.9965 | 0.9989 | 0.9997 | 0.9999 |

It can be seen from the above table that to meet the probability requirement of sequence detection, the approach of the invention is better than BP method. For example, to meet the requirement of Alignment Probability more than 90%, BP at least needs 5 times of reading while the approach of the invention only needs 3 readings to accomplish the task.

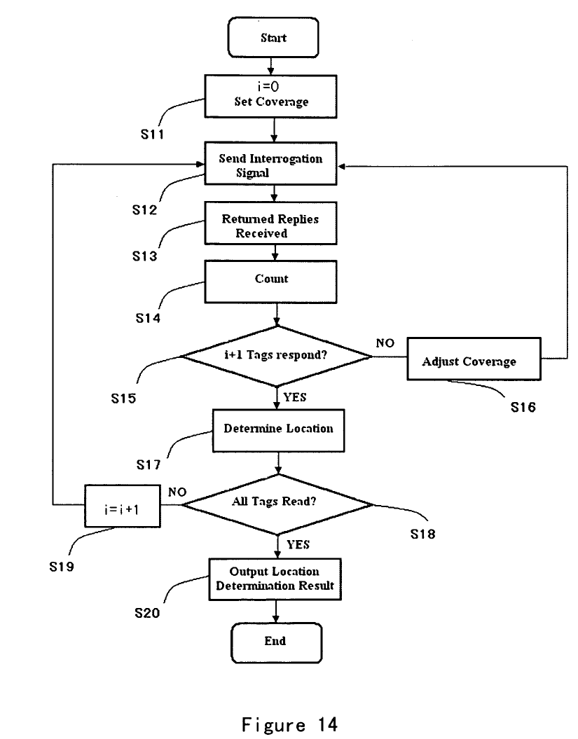

FIG. 14 shows the operation flow of the RFID reading apparatus 101 in the RFID system 100 shown in FIG. 6 for determining the arrangement location of a plurality of RFID tags 102.

As shown in FIG. 14, in step S11, the coverage setting unit 1013 sets the coverage of antenna 1010 such that only one of the plurality of RFID tags 102 (usually the one nearest to the RFID reading apparatus 101 in terms of spatial location) can receive an interrogation signal transmitted by the RFID reading apparatus 101 through the antenna 1010. In addition, the count value of the counter i (not shown) in the RFID reading apparatus 101 is reset to zero.

In step S12, the RFID reading apparatus 101 transmits an interrogation signal through the antenna 1010, and in step S13, the RFID reading apparatus 101 receives through the antenna 1010 a reply (replies) returned from the tag(s) in response to the interrogation signal.

In step S14, the reply counting unit 1012 classifies the received information by determining how many tags the received replies are returned from.

In step S15, the location determination unit 1011 determines based on the result of counting sent from the reply counting unit 1012 whether there are (i+1) tags that have responded to this interrogation signal, that is, whether a single-region is captured for the first transmission of interrogation signal, and whether a NM-region is captured for subsequent transmissions of interrogation signal. Specifically, if it is the first time that an interrogation signal is transmitted, then it is determined whether there is one tag responding to this interrogation signal. And for each time an interrogation signal is transmitted after the first time, it is determined whether there are (i+1) tags responding to the interrogation signal.

If the result of determination in step S15 is “NO”, that is, the replies currently received do not contain replies returned from (i+1) tags, then in step S16, the coverage setting unit 1013 adjusts the coverage of the antenna based on the currently received replies. For example, if the replies currently received contain replies returned from more than (i+1) tags, the coverage setting unit 1013 adjusts the coverage of the antenna 1010 to decrease it but not smaller than the coverage when an NM-region is captured last time. On the other hand, if the replies currently received contain replies returned from less than (i+1) tags, the coverage setting unit 1013 adjusts the coverage of the antenna 1010 to increase it.

The process returns to step S12 from step S16, where the location determination unit 1011 again transmits an interrogation signal in the case that the coverage of the antenna has been changed, and the flow thereafter is repeated.

On the other hand, if the result of determination in step S15 is “YES”, that is, the replies currently received contain replies returned from (i+1) tags, in other words, a single-region is captured for the first transmission of interrogation signal, and a NM-region is captured for subsequent transmissions of interrogation signal, then in step S17, the location determination unit 1011 determines the arrangement location of the plurality of tags 102. Next, if it is determined in step S18 that all the tags have been read, that is, have returned a reply, then in step S20, the location determination unit 1011 outputs the result of location determination. Otherwise, in step S19, the value of the counter i is incremented by 1, and the process returns to step S12 where again an interrogation signal is transmitted and the flow thereafter is repeated.

Although the invention has been described with reference to the specific preferred embodiments thereof, it is to be understood by those skilled in the art that various modifications in terms of form and detail can be made thereto without departing from the spirit and scope of the invention as defined by the attached claims.

For example, the tag identification system, the tag reading apparatus and the method for determining location of tags of the invention have been explained above with the RFID identification system, the RFID reading apparatus and the method for determining the location of RFID tags as examples respectively. However, it is to be understood by those skilled in the art that the tag identification system, tag reading apparatus and method for determining location of tags of the invention are not limited to the specific embodiments presented. The principle of the invention can also be applied in other situations where a tag reading apparatus is used to read data returned from high-density tags and determine the order (relative location) of the tags so as to determine the relative location of the items attached with the tags.

1. A tag identification system, comprising a tag reading apparatus which transmits interrogation signals and a plurality of tags arranged in a sequence, wherein
each of the plurality of tags is capable of returning a reply in response to a received interrogation signal;
the tag reading apparatus at least comprises a location determination unit which determines the arrangement location of the plurality of tags based on replies received by the tag reading apparatus which are returned by the plurality of tags in response to interrogation signals.

2. The tag identification system according to claim 1, wherein the tag reading apparatus further comprises a reply counting unit which counts the number of tags among the plurality of tags which have returned a reply in response to one interrogation signal, and sends the result of the counting to the location determination unit.

3. The tag identification system according to claim 1 or 2, wherein the tag reading apparatus further comprises a coverage setting unit which sets the coverage of the tag reading apparatus so that only a particular number of tags among the plurality of tags can receive an interrogation signal transmitted by the tag reading apparatus.

4. The tag identification system according to claim 3, wherein the coverage setting unit sets the coverage of the tag reading apparatus when a current interrogation signal is transmitted based on replies received by the tag reading apparatus which are returned in response to a previous interrogation signal so that the number of tags among the plurality of tags which can receive the current interrogation signal is increased or decreased as compared with the number of tags among the plurality of tags which can receive the previous interrogation signal.

5. The tag identification system according to claim 4, wherein the coverage setting unit sets the coverage of the tag reading apparatus when the current interrogation signal is transmitted so that the number of tags among the plurality of tags which can receive the current interrogation signal is 1 greater than the number of tags among the plurality of tags which can receive the previous interrogation signal.

6. The tag identification system according to claim 3, wherein
when a first one of a plurality of interrogation signals is transmitted by the tag reading apparatus to the plurality of tags, the coverage setting unit sets the coverage of the tag reading apparatus so that only one of the plurality of tags can receive the first interrogation signal.

7. The tag identification system according to claim 1 or 2, wherein the tag reading apparatus is a radio frequency identification (RFID) reading apparatus, and the plurality of tags are a plurality of RFID tags.

8. A tag reading apparatus capable of transmitting an interrogation signal and receiving a reply returned from a tag, comprising:
a location determination unit which determines the arrangement location of a plurality of tags arranged in a sequence based on replies received by the tag reading apparatus which are returned by the plurality of tags in response to a plurality of interrogation signals transmitted from the tag reading apparatus.

9. The tag reading apparatus according to claim 8, further comprising a reply counting unit which counts the number of tags among the plurality of tags which have returned a reply in response to one interrogation signal, and sends the result of the counting to the location determination unit.

10. The tag reading apparatus according to claim 8 or 9, further comprising a coverage setting unit which sets the coverage of the tag reading apparatus so that only a particular number of tags among the plurality of tags can receive an interrogation signal transmitted by the tag reading apparatus.

11. The tag reading apparatus according to claim 10, wherein the coverage setting unit sets the coverage of the tag reading apparatus when a current interrogation signal is transmitted based on replies received by the tag reading apparatus which are returned in response to a previous interrogation signal so that the number of tags among the plurality of tags which can receive the current interrogation signal is increased or decreased as compared with the number of tags among the plurality of tags which can receive the previous interrogation signal.

12. The tag reading apparatus according to claim 11, wherein the coverage setting unit sets the coverage of the tag reading apparatus when the current interrogation signal is transmitted so that the number of tags among the plurality of tags which can receive the current interrogation signal is 1 greater than the number of tags among the plurality of tags which can receive the previous interrogation signal.

13. The tag reading apparatus according to claim 10, wherein
when a first one of the plurality of interrogation signals is transmitted by the tag reading apparatus to the plurality of tags, the coverage setting unit sets the coverage of the tag reading apparatus so that only one of the plurality of tags can receive the first interrogation signal.

14. The tag reading apparatus according to claim 8 or 9, wherein the tag reading apparatus is a radio frequency identification (RFID) reading apparatus, and the plurality of tags are a plurality of RFID tags.

15. A method for determining the arrangement location of a plurality of tags using a tag reading apparatus, comprising:
an interrogation signal transmitting step for transmitting a plurality of interrogation signals to the plurality of tags from the tag reading apparatus; and
a location determination step for determining the arrangement location of the plurality of tags based on replies received by the tag reading apparatus which are returned by the plurality of tags in response to the plurality of interrogation signals.

16. The method according to claim 15, further comprising a reply counting step for counting the number of tags among the plurality of tags which have returned a reply in response to one interrogation signal, and wherein
in the location determination step, the arrangement location of the plurality of tags is determined based on the result of the counting and the sequence in which the received replies are retuned.

17. The method according to claim 15 or 16, further comprising a coverage setting step for setting the coverage of the tag reading apparatus so that only a particular number of tags among the plurality of tags can receive an interrogation signal transmitted by the tag reading apparatus.

18. The method according to claim 17, wherein the coverage setting step includes setting the coverage of the tag reading apparatus when a current interrogation signal is transmitted based on replies received by the tag reading apparatus which are returned in response to a previous interrogation signal so that the number of tags among the plurality of tags which can receive the current interrogation signal is increased or decreased as compared with the number of tags among the plurality of tags which can receive the previous interrogation signal.

19. The method according to claim 18, wherein the coverage setting step includes setting the coverage of the tag reading apparatus when the current interrogation signal is transmitted so that the number of tags among the plurality of tags which can receive the current interrogation signal is 1 greater than the number of tags among the plurality of tags which can receive the previous interrogation signal.

20. The method according to claim 17, wherein the coverage setting step includes, when a first one of the plurality of interrogation signals is transmitted by the tag reading apparatus to the plurality of tags, setting the coverage of the tag reading apparatus so that only one of the plurality of tags can receive the first interrogation signal.

21. The method according to claim 15 or 16, wherein the tag reading apparatus is a radio frequency identification (RFID) reading apparatus, and the plurality of tags are a plurality of RFID tags.
